(19) United States
(12) Patent Application Publication
(10) Pub. No.: US 2011/0100791 A1
(43) Pub. Date: May 5, 2011

(54) KEY MODULE AND METHOD OF MAKING THE SAME

(75) Inventors: YAN-DONG ZHU, Shenzhen (CN); DA-YU WANG, Shenzhen (CN)

(73) Assignee: HON HAI PRECISION INDUSTRY CO., LTD., Tu-Cheng (TW)

(21) Appl. No.: 12/915,079

(22) Filed: Oct. 29, 2010

(30) Foreign Application Priority Data
Oct. 29, 2009 (CN) 200910309008.5

(51) Int. Cl. H01H 13/76; B29C 45/04

(52) U.S. Cl. 200/5 A; 264/297.2

(57) ABSTRACT

A key module includes a light guide board made from polycarbonate material and a plurality of elastic keypads made from thermoplastic elastomer material and injected molding with the light guide board with a push member projecting above the light guiding board.

### BACKGROUND OF THE INVENTION

1. Field of the Invention

The present invention relates to a key module and method of making the same, and more particularly to a key module used in portable electronic devices and method of making the same.

2. Description of the Related Art

A traditional key module comprises a front panel, a plurality of elastic keypads assembled to the front panel and a light guide board disposed under the front panel. A light-emitting element is adjacent to the light guide board and lights from the light-emitting element enter the elastic keypads via the light guide member. The key module is used for user input interface to input data and select function of portable electronic devices. With a miniaturization trend of the portable electronic devices, how to induce a volume of the key module is considered.

In view of the above, a new key module that overcomes the above-mentioned disadvantages is desired.

### SUMMARY OF THE INVENTION

Accordingly, an object of the present invention is to provide a key module and method of making the same.

To fulfill the above-mentioned object, a key module includes a light guide board made from polycarbonate material and a plurality of elastic keypads made from thermoplastic elastomer material and injected molding with the light guide board with a push member projecting above the light guiding board.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a key module;

FIG. 2 is a top exploded view of the key module of FIG. 1;

FIG. 3 is a bottom exploded view of the key module of FIG. 1; and

FIG. 4 is a cross sectional view of the key module taken along line 4-4 in the FIG. 1.

### DETAILED DESCRIPTION OF THE PREFERRED EMBODIMENT OF THE INVENTION

Reference will now be made to the drawings to describe the present invention in detail.

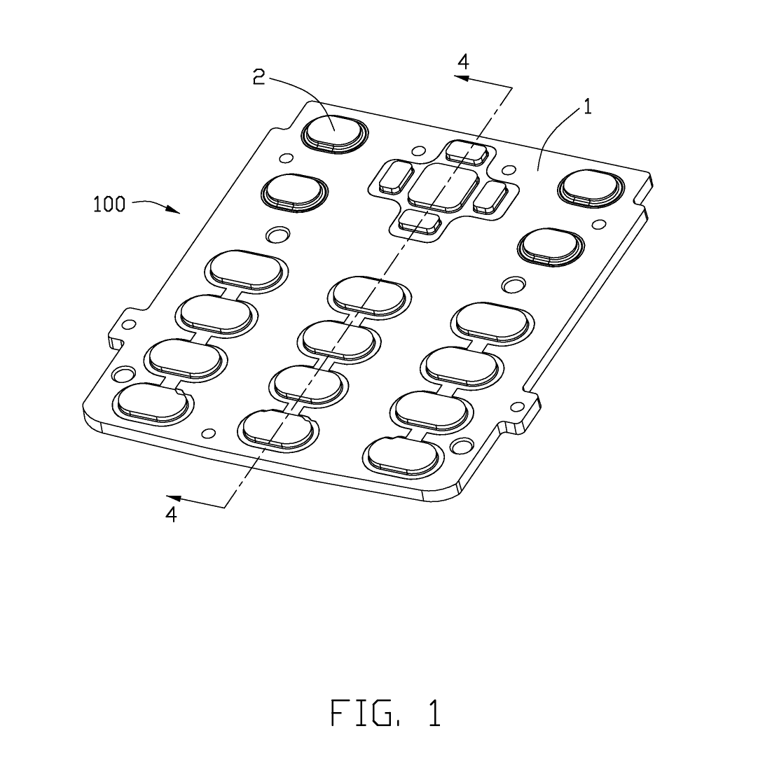

Referring to FIG. 1, a key module 100 comprises a light guide board 1 and a plurality of elastic keypads 2 injected molding with the light guide board 1.

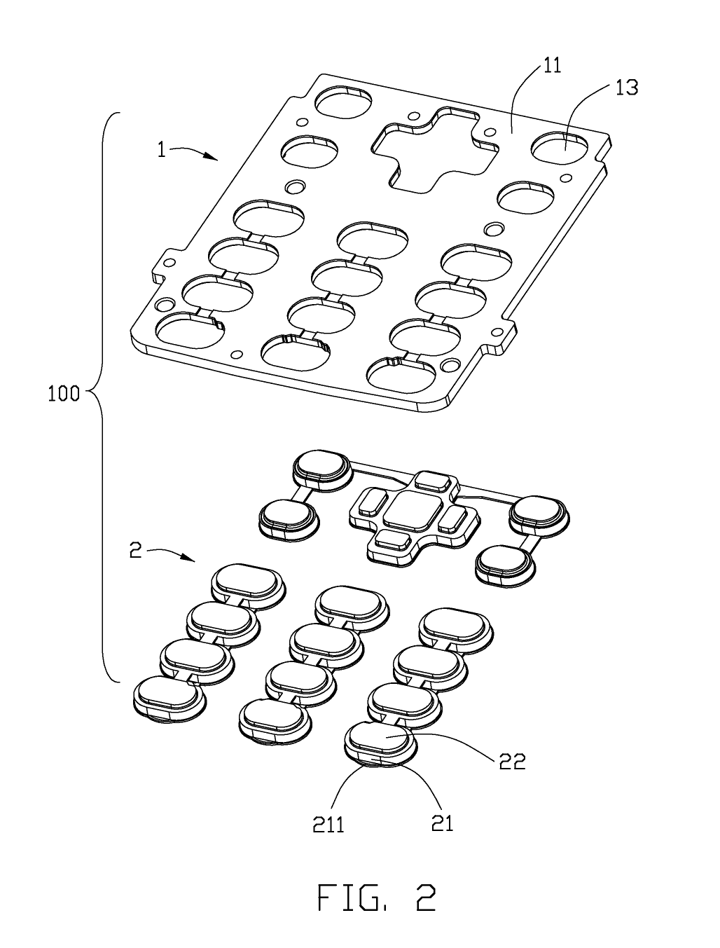

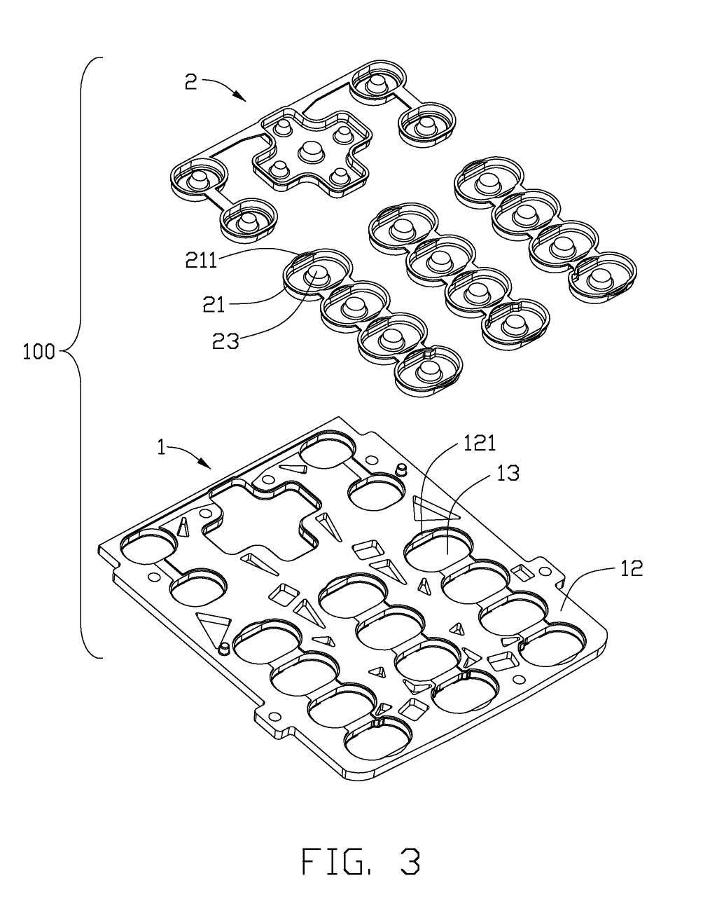

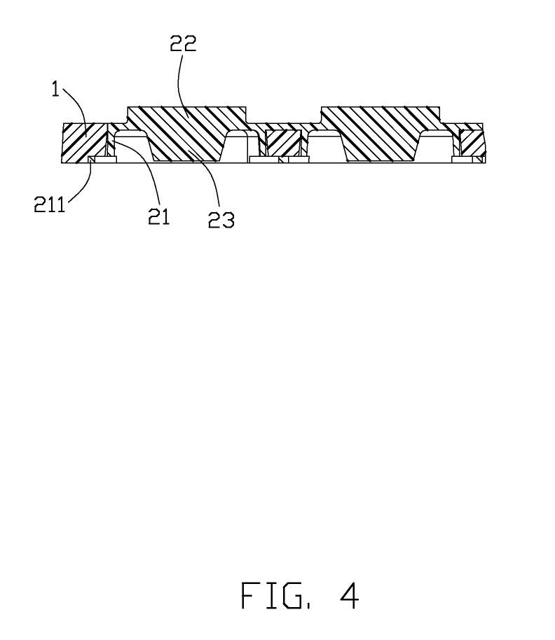

The light guide board 1 is made from polycarbonate (PC) material. The elastic keypads 2 are made from thermoplastic elastomer (TPE) material. The TPE material can inject molding with a hard material such as PC and is provided with a good viscousness with the hard material. So the elastic keypads 2 can inject molding with the light guide board 1 and prevent the elastic keypads 2 from dividing from the light guide board 1. Referring to FIGS. 2-3, the light guide board 1 defines a plurality of through holes 13 running through a top face 11 and a bottom face 12 of the light guide board 1 opposite to each other. The elastic keypads 2 are injected molding in the through holes 13. Each elastic keypad 2 defines a push member 22 projecting above the light guiding board 1, a retaining wall 21 extending from a peripheral edge of the push member 22 and an actuator portion 23 extending from a bottom center of the push member. Referring to FIG. 4, the retaining wall 21 defines an elastic portion 211 at a distal end abutting against a bottom face 121 of the through hole 13. Some elastic keypads 1 connect with each other. The actuator portions 23 of the other keypads are not droved in condition that one elastic keypad is pushed. Lights from a light-emitting source (not shown) enter the elastic keypads 2 via the light guide board 1.

The key module is made by injection molding. Firstly, preparing two pairs of molding dies, a first pair of molding die used to mold a light guide board 1 and a second pair of molding die used to mold a plurality of elastic keypads 2. The first pair of molding die comprises a first female molding and a first male molding and the second pair of molding die comprises a second female molding and a second male molding. The two female molding of the first pair of molding die and the second pair of molding die are the same. Secondly, preparing an injection molding machine with at least two nozzles, a first nozzle shooting PC material and a second nozzle shooting TPE material. Thirdly, putting the female molding at an immovable table of the injection molding machine and putting the male moldings of the first pair of molding die and the second pair of molding die at different locations of a movable table of the inject-molding machine. Fourthly, removing the movable table of the injection molding machine to move the female molding of the first pair of molding die to an injection location joining with the female molding, the first nozzle shooting PC material into the first pair of molding die to mold the light guide board 1. Finally, moving the female molding of the second pair of molding die to the injection location joining with the female molding, the second nozzle shooting TPE material to the second pair of molding die to inject molding the elastic keypads 2 on the base of light guide board 1.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A key module, comprising:
a light guide board made from polycarbonate material;
a plurality of elastic keypads made from thermoplastic elastomer material and injected molding with the light guide board with a push member projecting above the light guiding board.

2. The key module as claimed in claim 1, wherein the light guide board defines a plurality of through holes, the elastic keypads are injected molding in the through holes.

3. The key module as claimed in claim 2, wherein each elastic keypad defines a retaining wall extending from a peripheral edge of the push member and an actuator portion extending from a bottom center of the push member, the retaining wall abuts against a bottom face of the through hole.

4. The key module as claimed in claim 3, wherein some elastic keypads connect with each other and the actuator portions of the other keypads are not droved in a condition that one elastic keypad is pushed.

5. A method of making a key module, comprising
preparing two pairs of molding dies, a first pair of molding die used to mold a light guide board and a second pair of molding die used to mold a plurality of elastic keypads;
preparing an injection molding machine with at least two nozzles, a first nozzle shooting polycarbonate material and a second nozzle shooting thermoplastic elastomer material;
putting the first pair of molding die and the second pair of molding die at different locations of a movable table of the injection molding machine;
removing the movable table of injection molding machine to move the first pair of molding die to an injection location, the first nozzle shooting the polycarbonate material into the first pair of molding die to mold the light guide board;
moving the second pair of molding die to the injection location, the second nozzle shooting the thermoplastic elastomer material to the second pair of molding die to inject molding the elastic keypads on the base of light guide board.

6. The method of making the key module as claimed in claim 5, wherein the first pair of molding die comprises a first female molding and a first male molding and the second pair of molding die comprises a second female molding and a second male molding, the two female molding being the same.

7. A key module comprising:
a light guide board with light transmission function thereof and defining a plurality of through holes in one row along a longitudinal direction and a plurality of linking sections each between every adjacent two through holes; and
a plurality of elastic keypads made from elastomer material and insert molded with the light guide board under condition that said elastic keypads are integrated with one another via corresponding linking portions each between the adjacent two keypads; wherein
each linking section is surrounded by the corresponding linking portion except in a transverse direction perpendicular to said longitudinal direction.

8. The key module as claimed in claim 7, wherein there are more than one rows of said keypads and the corresponding through holes, and at least two rows of said keypads are further unified together in said transverse direction.

9. The key module as claimed in claim 8, wherein a bottom face of each of said linking portion defines a sandglass configuration to expose the corresponding linking section around a narrowed waist.
